(19) United States
(12) Patent Application Publication
(10) Pub. No.: US 2026/0154094 A1
(43) Pub. Date: Jun. 4, 2026

(54) METHOD, COMPUTER DEVICE, AND NON-TRANSITORY COMPUTER-READABLE RECORDING MEDIUM TO PROVIDE ADVERTISING PERFORMANCE REPORT IN INTERACTIVE VISUALIZATION FORMAT

(71) Applicant: NAVER CORPORATION, Seongnam-si (KR)

(72) Inventors: Yohan BAE, Seongnam-si (KR); Sang Won KO, Seongnam-si (KR)

(21) Appl. No.: 19/252,478

(22) Filed: Jun. 27, 2025

(30) Foreign Application Priority Data
Dec. 3, 2024 (KR) 10 2024 0177958

(51) Int. Cl. G06F 9/451; G06Q 30/0242

(52) U.S. Cl. CPC G06F 9/451; G06Q 30/0244

(57) ABSTRACT

A method of providing an advertising performance report may include configuring advertising performance data of a unit selected by an advertiser in the form of a visualized chart widget; and displaying a plurality of advertising performance chart widgets on a data visualization dashboard, and an interaction functional element may be included between the advertising performance chart widgets displayed on the data visualization dashboard.

### CROSS-REFERENCE TO RELATED APPLICATION(S)

This U.S. non-provisional application claims the benefit of priority under 35 U.S.C. § 119 to Korean Patent Application No. 10-2024-0177958 filed on Dec. 3, 2024, in the Korean Intellectual Property Office (KIPO), the entire contents of which are incorporated herein by reference.

### BACKGROUND OF THE INVENTION

### Field of Invention

One or more example embodiments of the following description relate to technology for providing an advertising performance report.

Description of Related Art

An advertising performance indicator (lift metric) is most important in evaluating the performance of advertising campaigns.

The advertising performance indicator evaluates the effectiveness of a given advertisement by measuring an increase in conversions attributed to the advertising campaigns.

The advertising performance indicator may be utilized by an advertiser to determine the effectiveness of advertising content and/or the effectiveness of an advertising platform through which the advertising content is displayed.

For example, Korean Patent Laid-Open Publication No. 10-2009-0119046, published on Nov. 19, 2009, describes technology for providing the objective index for advertising performance.

### BRIEF SUMMARY OF THE INVENTION

One or more example embodiments of the present invention may provide an advertising performance report in the form of a visualized chart widget.

One or more example embodiments may readily add or modify an advertising performance chart according to a condition desired by an advertiser.

One or more example embodiments may explore data by applying a filter through interaction between advertising performance charts.

One or more example embodiments may recommend or change a strategy for improving advertising performance based on data being explored through a chart widget.

According to at least one example embodiment, there is provided an advertising performance report providing method of a computer device including at least one processor, the method including configuring, by the at least one processor, advertising performance data of a unit selected by an advertiser in the form of a visualized chart widget; and displaying, by the at least one processor, a plurality of advertising performance chart widgets on a data visualization dashboard, wherein an interactive functional element is included between the advertising performance chart widgets displayed on the data visualization dashboard.

According to an aspect of the present invention, the configuring may include, in response to a selection from the advertiser on one of advertising performance indicators or a selection from the advertiser on a single segment that is a unit for grouping advertising-related data and a single advertising performance indicator, configuring advertising performance data of a corresponding condition as a chart widget.

According to another aspect, the configuring may include configuring the advertising performance chart widgets by visualizing the advertising performance data using a chart type selected by the advertiser.

According to still another aspect, the displaying may include adding or deleting the advertising performance chart widgets through the data visualization dashboard.

According to still another aspect, the displaying may include displaying the advertising performance chart widgets using a placement location or order adjusted by the advertiser.

According to still another aspect, the advertising performance report providing method may further include performing, by the at least one processor, data filtering through interaction between the advertising performance chart widgets.

According to still another aspect, the performing may include, in response to a selection on a specific item from one chart widget among the advertising performance chart widgets, filtering data of another chart widget with data corresponding to the specific item.

According to still another aspect, the advertising performance report providing method may further include providing, by the at least one processor, advertising strategy information based on data being explored through the advertising performance chart widget.

According to still another aspect, the providing may include recommending the advertising strategy information to optimize at least one of a budget and targeting of an advertising campaign.

According to still another aspect, the providing may include changing settings related to an advertising operation of the advertiser based on the advertising strategy information.

According to at least one example embodiment, there is provided a non-transitory computer-readable recording medium storing a computer program that, when executed by a processor, causes the processor to execute the advertising performance report providing method on the computer device.

According to at least one example embodiment, there is provided a computer device including at least one processor configured to execute instructions readable by the computer device, wherein the at least one processor performs a process of configuring advertising performance data of a unit selected by an advertiser in the form of a visualized chart widget; and a process of displaying a plurality of advertising performance chart widgets on a data visualization dashboard, and an interaction functional element is included between the advertising performance chart widgets displayed on the data visualization dashboard.

According to some example embodiments, it is possible to understand data more intuitively and visually than a simple table format by providing an advertising performance report in the form of a visualized chart widget.

According to some example embodiments, it is possible to provide a highly effective report on the advertiser side by readily configuring and adding an advertising performance chart according to a condition desired by an advertiser.

According to some example embodiments, it is possible to provide an easy and convenient data analysis environment by providing a function of exploring data by applying a filter through interaction between advertising performance charts.

According to some example embodiments, it is possible to support an active and efficient advertising operation by recommending or changing a strategy for improving advertising performance based on data being explored through a chart widget.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to one example embodiment;

FIG. 2 is a block diagram illustrating an example of a computer device according to one example embodiment;

FIG. 3 is a flowchart illustrating an example of a method performed by a computer device according to one example embodiment;

FIGS. 4 to 7 illustrate examples of a data visualization dashboard according to at least one example embodiment;

FIGS. 8 and 9 illustrate examples of a data filter between advertising performance charts according to at least one example embodiment; and

FIG. 10 illustrates an example of recommending an advertising strategy based on advertising performance according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

The example embodiments relate to technology for providing an advertising performance report.

The example embodiments including disclosures herein may provide advertising performance data as a chart widget that is interactive between charts in the form of a visualized chart.

An advertising performance report providing apparatus according to the example embodiments may be implemented by at least one computer device, and an advertising performance report providing method according to the example embodiments may be performed through at least one computer device included in the advertising performance report providing apparatus according to the example embodiments. Here, a computer program according to an example embodiment may be installed and executed on the computer device, and the computer device may perform the advertising performance report providing method according to the example embodiments under the control of the executed computer program. The aforementioned computer program may be stored in a computer-readable recording medium to computer-implement the advertising performance report providing method in conjunction with the computer device.

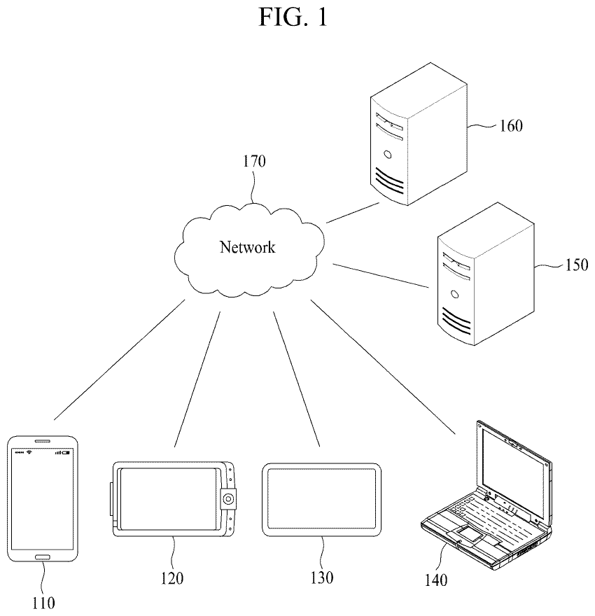

FIG. 1 illustrates an example of a network environment according to at least one example embodiment of the present invention. Referring to FIG. 1, the network environment may include a plurality of electronic devices 110, 120, 130, 140, a plurality of servers 150, 160, and a network 170. FIG. 1 is provided as an example only. The number of electronic devices or the number of servers is not limited thereto. Also, the network environment of FIG. 1 describes one example among environments applicable to the example embodiments and an environment applicable to the example embodiments is not limited to the network environment of FIG. 1.

Each of the plurality of electronic devices 110, 120, 130, 140 may be a fixed terminal or a mobile terminal that is configured as a computer device. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a smartphone as an example of the electronic device 110, the electronic device 110 used herein may refer to one of various types of physical computer devices capable of communicating with other electronic devices 120, 130, 140, and/or the servers 150, 160 over the network 170 in a wireless or wired communication manner.

The communication scheme is not limited and may include a near field wireless communication scheme between devices as well as a communication scheme using a communication network (e.g., mobile communication network, wired Internet, wireless Internet, broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150, 160 may be configured as a computer device or a plurality of computer devices that provides an instruction, a code, a file, content, a service, etc., through communication with the plurality of electronic devices 110, 120, 130, 140 over the network 170. For example, the server 150 may be a system that provides a service (e.g., advertising performance report providing service) to the plurality of electronic devices 110, 120, 130, 140 connected over the network 170.

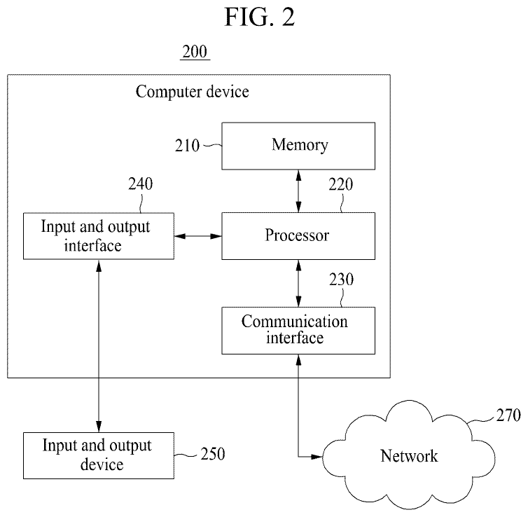

FIG. 2 is a block diagram illustrating an example of a computer device according to at least one example embodiment. Each of the plurality of electronic devices 110, 120, 130, 140 of FIG. 1 or each of the servers 150, 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as a ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. Other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a microphone, a keyboard, a mouse, etc., and an output device of the I/O device 250 may include a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include greater or less number of components than those shown in FIG. 2. For example, the computer device 200 may include at least a portion of the I/O device 250, or may further include other components, for example, a transceiver, a database, etc.

Hereinafter, example embodiments of the present invention for providing an advertising performance report in an interactive visualization format are described.

A general advertising platforms provides a function that allows an advertiser to verify the advertising performance for an effective advertising operation. The advertiser may verify metrics for advertisement campaign performance and may operate advertisements through settings, such as campaigns, sub-advertising groups or material of the campaigns, keywords, and the like, based on the performance.

Existing advertising performance reports are mainly provided in a table format. When an advertiser selects an analysis unit (e.g., advertising account, campaign, advertising group, advertising material, etc.), an analysis period (e.g., all, day, week, month, hour, etc.), a placement location (e.g., all, media group, etc.), audience (e.g., all, age, gender, device, OS, etc.), and the like, the existing report simply displays advertising performance data according to the condition in a table format.

The advertising performance report in a table format provides data using text or numbers, making it difficult to analyze data or identify advertising performance since the data is not easily understood at a glance.

Therefore, the example embodiment may provide the advertising performance report in the form of a visualized chart widget and, particularly, may quickly and easily explore detailed data based on a specific item through an interactive functional element between a data filter and a chart.

The processor 220 of the computer device 200 may be implemented as a component for performing the following advertising performance report providing method. Depending on example embodiments, the components of the processor 220 may be optionally included in or excluded from the processor 220. Also, depending on example embodiments, the components of the processor 220 may be separated or merged for functional representations of the processor 220.

The processor 220 and the components of the processor 220 may control the computer device 200 to perform operations included in the following advertising performance report providing method. For example, the processor 220 and the components of the processor 220 may be implemented to execute an instruction according to a code of at least one program and a code of an operating system (OS) included in the memory 210.

Here, the components of the processor 220 may be representations of different functions performed by the processor 220 according to an instruction provided from a program code stored in the computer device 200.

The processor 220 may read a necessary instruction from the memory 210 to which instructions related to the control of the computer device 200 are loaded. In this case, the read instruction may include an instruction for controlling the processor 220 to execute operations described below.

The operations included in the advertising performance report providing method described below may be performed in order different from the illustrated order, and some of the operations may be omitted or an additional process may be further included.

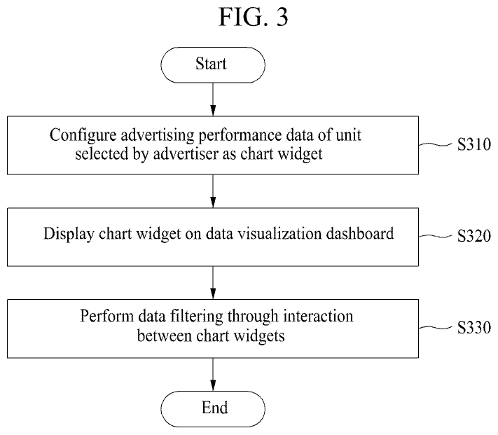

FIG. 3 is a flowchart illustrating an example of a method performed by a computer device according to at least one example embodiment.

Referring to FIG. 3, in operation S310, the processor 220 may configure advertising performance data of a unit selected by an advertiser in the form of a visualized chart widget. The advertiser may select a single advertising performance indicator to verify advertising performance, or may select a data unit (hereinafter, segment) to be analyzed for advertising performance and an advertising performance indicator one by one. The advertising performance indicator plays an important role in evaluating and improving the success of marketing strategy and may refer to an indicator for measuring the performance of an advertisement operated by the advertiser, such as the number of impressions, the number of clicks, cost per click, and the number of conversions. The segment may refer to a unit that may group data related to advertisements, such as a campaign, a campaign objective, an advertising group, advertising material, placement location, age, and date. The processor 220 may configure an advertising performance chart according to the condition desired by the advertiser for an advertisement operated by the advertiser. That is, the processor 220 may configure the advertising performance report of the corresponding condition as a chart widget by selecting one of the advertising performance indicators or by selecting the advertising performance indicators and the segments one by one. The advertising performance chart widget may be configured through a selection from the advertiser on a chart type, such as a vertical bar chart, a broken line chart, a pie chart, a horizontal bar chart, an area chart, and a scatter chart.

In operation S320, the processor 220 may provide a data visualization dashboard for verifying the advertising performance to the advertiser. Here, the advertising performance chart widget configured in operation S310 may be displayed on the data visualization dashboard. The data visualization dashboard refers to an interface screen for providing the advertising performance report and is a screen designed to display at least one advertising performance chart widget on a single screen and to allow data exploration. The processor 220 may readily add or delete the advertising performance chart widget configured according to the condition desired by a user through the data visualization dashboard. In addition to the advertising performance indicators or segments that constitute the advertising performance chart widget, a chart type, a placement location, and placement order, of the advertising performance chart widget may all be adjusted by the advertiser.

In operation S330, the processor 220 may perform data filtering through interaction between the advertising performance chart widgets within the data visualization dashboard. In response to a selection on a specific item in a specific chart widget among the advertising performance chart widgets displayed on the data visualization dashboard, the processor 220 may filter data of another chart widget. In the example embodiment, the advertising performance chart widgets may include an interactive functional element between charts for data filtering. Using a data filter and the interactive functional element between charts, it is possible to change a data inquiry period or to quickly verify detailed data based on the specific item. The interactive functional element between chart widgets may include a data filter that, in response to a selection from the advertiser on a specific item within a specific chart area, changes data of another chart linked to the chart to the content related to the selected item. While viewing a plurality of advertising performance chart widgets displayed on one screen at a time through the data visualization dashboard, comprehensive insight may be derived. Also, a data filter function between chart widgets may be used to quickly and readily explore detailed data by item.

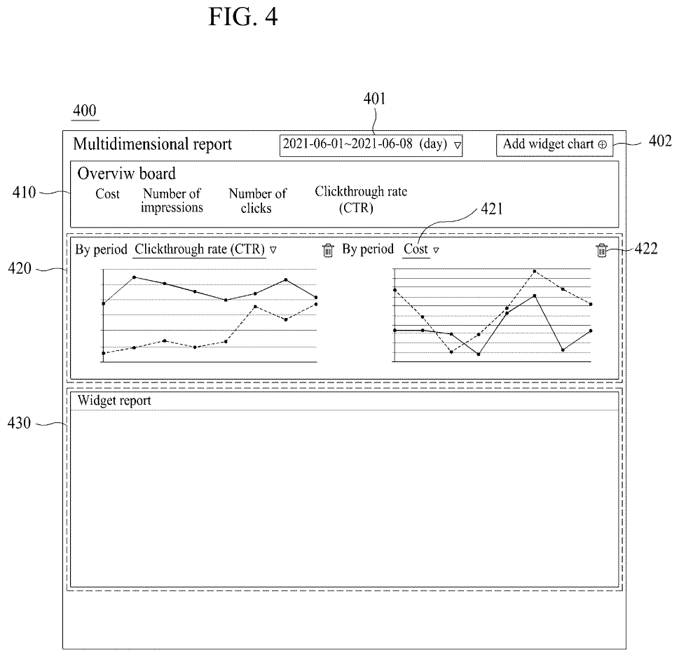

FIGS. 4 to 7 illustrate examples of a data visualization dashboard according to at least one example embodiment.

Referring to FIG. 4, a data visualization dashboard 400 may include an overview board area 410 and an overview chart area 420 to periodically verify the advertising performance.

A period setting interface 401 for setting an advertising performance analysis period may be included in a top header of the data visualization dashboard 400.

The overview board area 410 may display the sum (or average) of key indicators within a period set through the period setting interface 401. The overview board area 410 may receive performance indicators corresponding to the same period in the past based on the period set through the period setting interface 401 and may show an amount of change and a rate of change compared to indicators corresponding to a current analysis period.

The overview chart area 420 may show key indicators, such as the number of impressions, the number of clicks, cost, and the number of conversions by period, in the form of a graph. Each indicator chart displayed within the overview chart area 420 may include an indicator setting interface 421 for setting an indicator and a deletion interface 422 for deleting a corresponding indicator chart.

An advertiser may intuitively verify key indicators by period through the overview board area 410 and the overview chart area 420.

In particular, in the example embodiment, the data visualization dashboard 400 may include a widget report area 430 using a chart widget to analyze the advertising performance in detail.

The data visualization dashboard 400 may include a widget addition interface 402 for adding an advertising performance chart widget.

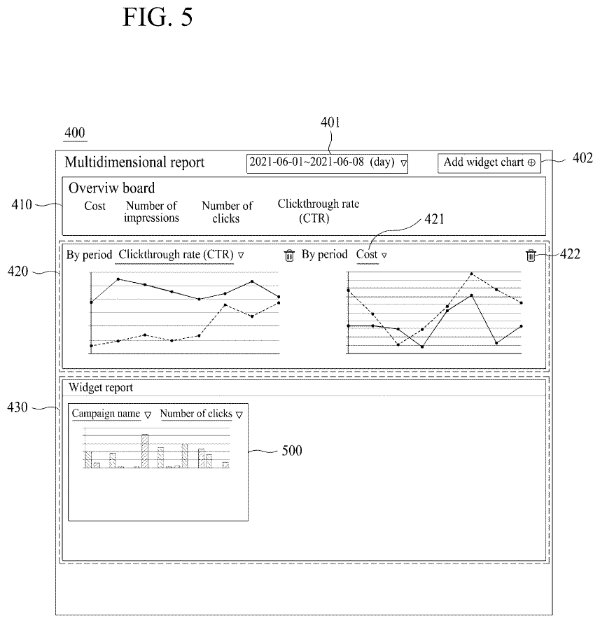

In response to a selection on the widget addition interface 402 in the data visualization dashboard 400, a chart widget 500 in which an advertising performance report of a condition selected by the advertiser is configured in the visualized format may be displayed within the widget report area 430 as shown in FIG. 5.

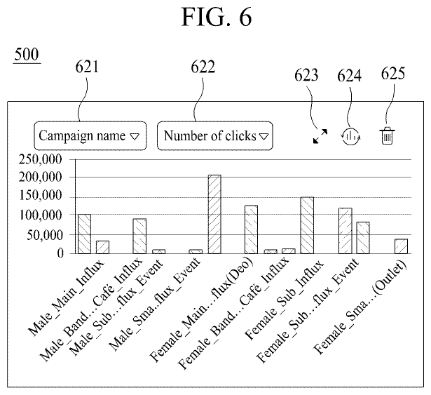

FIG. 6 illustrates an example of a configuration of the advertising performance chart widget 500.

Referring to FIG. 6, the advertising performance chart widget 500 added on the widget report area 430 may include a segment setting interface 621 for setting a segment (e.g., campaign, campaign goal, advertising group, advertising material, placement location, age, date, etc.), an indicator setting interface 622 for setting an advertising performance indicator (e.g., number of impressions, number of clicks, cost per click, number of conversions, etc.), a size setting interface 623 for setting a chart size, a chart setting interface 624 for setting a chart type (e.g., vertical bar chart, broken line chart, pie chart, horizontal bar chart, area chart, scatter chart, etc.), and a deletion interface 625 for deleting a corresponding chart widget.

In response to a selection from the advertiser on a single segment and a single advertising performance indicator through the segment setting interface 621 and the indictor setting interface 622, respectively, the chart widget 500 in which an advertising performance report of a condition selected by the advertiser is configured in a chart type selected through the chart setting interface 624 may be displayed on the widget report area 430.

For example, when the advertiser selects ‘campaign’ from among segments, selects ‘number of clicks’ from among indicators, and selects the vertical bar chart as the chart type, the advertising performance chart widget 500 may configure campaign-number of clicks performance data as a vertical bar-type chart widget, which may be added on the widget report area 430 of the data visualization dashboard 400.

The processor 220 may provide an editing function, such as correct or delete, for each advertising performance chart widget 500 added on the widget report area 430 of the data visualization dashboard 400.

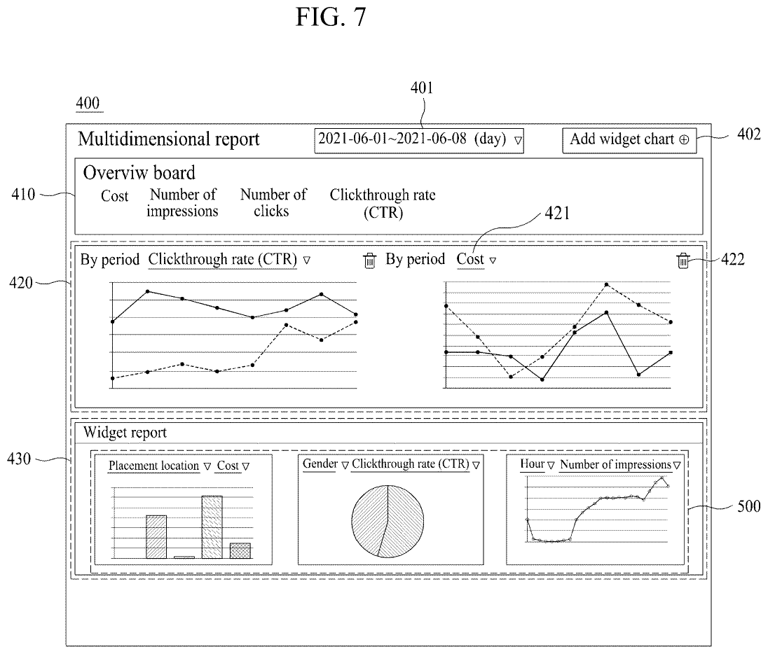

Referring to FIG. 7, the processor 220 may collect a plurality of advertising performance chart widgets 500 added by the advertiser and may display the same on a single screen through the widget report area 430 of the data visualization dashboard 400.

The processor 220 may readily adjust a location of the advertising performance chart widget 500 by supporting a drag and drop within the widget report area 430 of the data visualization dashboard 400. That is, a placement location or order of the advertising performance chart widget 500 may be adjusted by the advertiser.

The advertiser may verify the advertising performance while viewing the advertising performance chart widget 500 added on the widget report area 430 of the data visualization dashboard 400 at a time.

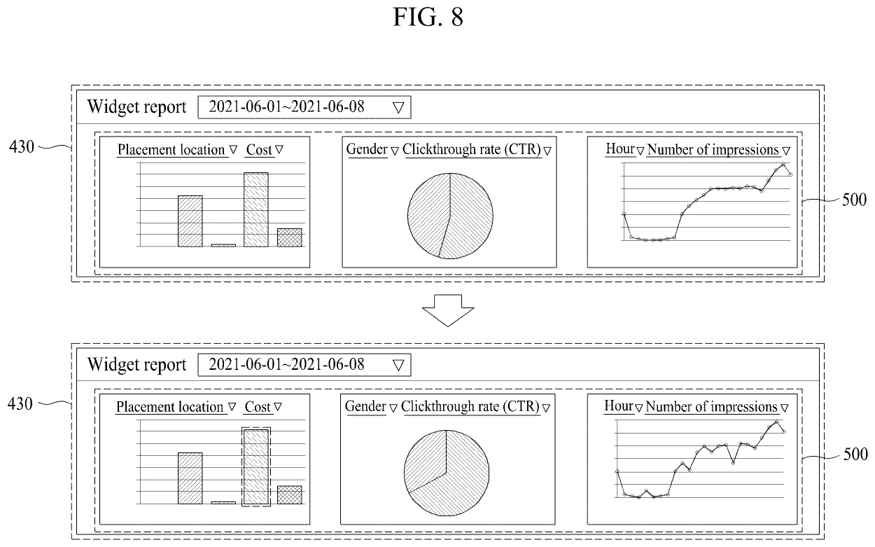

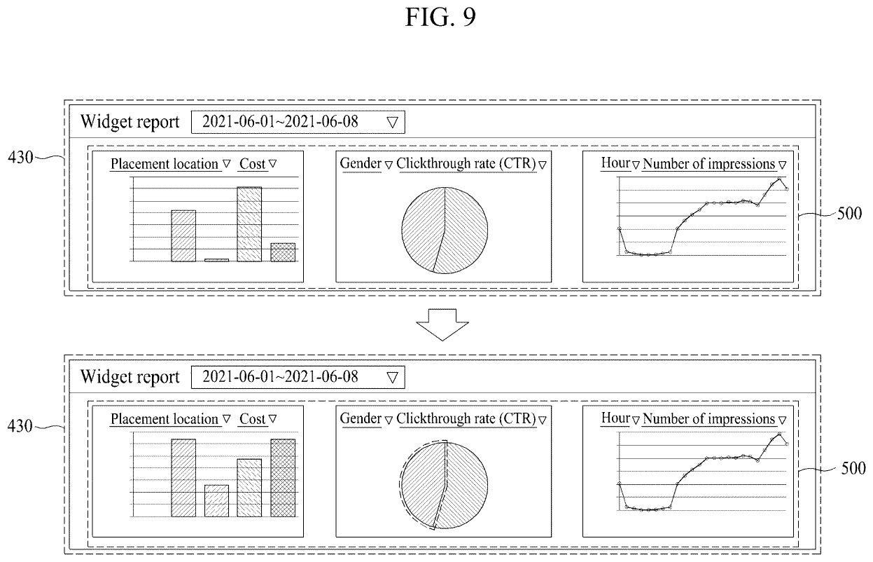

Therefore, the example embodiment may provide an advertising performance report in the form of a visualized chart widget, and may also configure and display an advertising performance chart widget of a condition desired by the advertiser on a single screen. Without restriction on a dimension, it is possible to configure the advertising performance chart widget based on the condition desired by the advertiser and to analyze advertising performance data. FIGS. 8 and 9 illustrate examples of a data filter between advertising performance charts according to at least one example embodiment.

The processor 220 may perform data filtering through interaction between the advertising performance chart widgets 500 within the widget report area 430 of the data visualization dashboard 400. In response to a selection on a specific item on a specific advertising performance chart widget 500, the processor 220 may filter data of another advertising performance chart widget 500.

For detailed analysis, drilldown filtering may be applied by selecting a subsegment within the advertising performance chart widget 500. Here, a filter may be applied to all remaining chart widgets excluding a chart widget from which the subsegment is selected.

For example, it is assumed that a campaign-by-campaign click count chart, a gender-by-gender clickthrough rate chart, an hourly impression count chart, a placement location-by-placement location cost chart, an age-by-age click count chart, and a day-of-week click count chart are added on the widget report area 430 of the data visualization dashboard 400 as the advertising performance chart widgets 500.

Referring to FIG. 8, in response to a selection on ‘mobile main’ that is a subsegment from a placement location-by-placement location cost chart widget among the advertising performance chart widgets 500 of the widget report area 430, the corresponding filter may be applied to other chart widgets.

That is, in response to the selection on the item ‘mobile main’ in the placement location-by-placement location cost chart, data of the campaign-by-campaign click count chart, the gender-by-gender clickthrough rate chart, the hourly impression count chart, the age-by-age click count chart, and the day-of-week click count chart may be filtered out using ‘mobile main’ data, such that the advertising performance chart widgets 500 may be reorganized and displayed to focus on data corresponding to ‘mobile main.’

As another example, referring to FIG. 9, in response to a selection on ‘female’ as a subsegment from the gender-by-gender clickthrough rate chart among the advertising performance chart widgets 500 of the widget report area 430, the corresponding filter may be applied to the remaining chart widgets.

Here, in response to the selection on ‘female’ in the gender-by-gender clickthrough rate chart, the campaign-by-campaign click count chart, the hourly impression count chart, the placement location-by-placement location cost chart, the age-by-age click count chart, and the day-of-week click count chart may be filtered using ‘female’ data and then displayed. In other words, the advertising performance chart widgets 500 may be reorganized and displayed to emphasize data relating to females

The example embodiment may activate a chart filter comparison function through widget drilldown filtering between the advertising performance chart widgets 500 added on the widget report area 430 of the data visualization dashboard 400, and may visually verify and analyze the filtering effect.

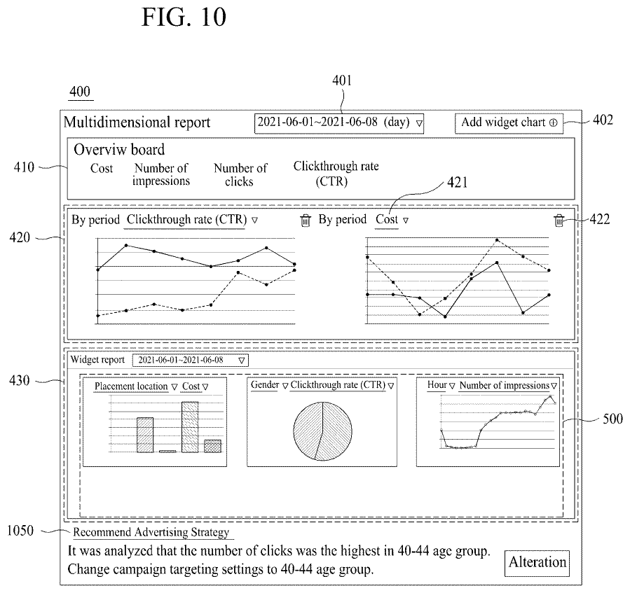

FIG. 10 illustrates an example of recommending an advertising strategy based on advertising performance according to at least one example embodiment.

The advertiser may verify the advertising performance through the data visualization dashboard 400 for operating advertisements and may differently adjust settings, such as campaign, advertising group, advertising material, keyword, and targeting.

The processor 220 may recommend or change advertising operation settings of the advertiser according to a strategy for improving the advertising performance based on data being explored through a chart widget.

Referring to FIG. 10, the processor 220 may provide advertising strategy information 1050 for improving the advertising performance based on data of the advertising performance chart widget 500 that the advertiser is currently exploring through the widget report area 430 of the data visualization dashboard 400.

The advertising strategy information 1050 may be generated by a recommendation model using artificial intelligence (AI) technology for advertising performance data of the advertiser, and budget and targeting of an advertising campaign may be optimized through an AI recommendation model.

The processor 220 may recommend the advertising strategy information 1050 to the advertiser, and, depending on example embodiments, may change settings related to an advertising operation automatically or in response to an advertiser request based on the advertising strategy information 1050.

For example, the processor 220 may verify a target (gender, age, interest, etc.) corresponding to the largest number of clicks for a specific campaign and may change targeting settings of a sub-advertising group of the campaign as a target with the highest number of impressions.

As another example, the processor 220 may identify an advertising image with the highest clickthrough rate (CTR) in the specific campaign and may change a representative advertising material of the campaign with the advertising image with the highest clickthrough rate.

According to the example embodiments of the present invention, it is possible to understand data more intuitively and visually than a simple table format by providing an advertising performance report in the form of a visualized chart widget.

Also, according to some example embodiments, it is possible to provide a highly effective report on the advertiser side by readily configuring and adding an advertising performance chart according to a condition desired by an advertiser.

Also, according to some example embodiments, it is possible to provide an easy and convenient data analysis environment by providing a function of exploring data by applying a filter through interaction between advertising performance charts.

Also, according to some example embodiments, it is possible to support an active and efficient advertising operation by recommending or changing a strategy for improving advertising performance based on data being explored through a chart widget.

The apparatuses or processing device described herein may be implemented using hardware components, software components, and/or the combination of the hardware components and the software components. For example, the apparatuses or the processing device described herein may be implemented using one or more computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An advertising performance report providing method of a computer device comprising at least one processor, the method comprising:
configuring, by the at least one processor, advertising performance data of a unit selected by an advertiser in the form of a visualized chart widget; and
displaying, by the at least one processor, a plurality of advertising performance chart widgets on a data visualization dashboard,
wherein an interactive functional element is included between the advertising performance chart widgets displayed on the data visualization dashboard.

2. The method of claim 1, wherein the configuring of the advertising performance data comprises, in response to a selection from the advertiser on one of advertising performance indicators or a selection from the advertiser on a single segment that is a unit for grouping advertising-related data and a single advertising performance indicator, configuring advertising performance data of a corresponding condition as a chart widget.

3. The method of claim 1, wherein the configuring of the advertising performance data comprises configuring the advertising performance chart widgets by visualizing the advertising performance data using a chart type selected by the advertiser.

4. The method of claim 1, wherein the displaying of the plurality of advertising performance chart widgets comprises adding or deleting the advertising performance chart widgets through the data visualization dashboard.

5. The method of claim 1, wherein the advertising performance chart widgets are displayed using a placement location or order adjusted by the advertiser.

6. The method of claim 1, further comprising:
performing, by the at least one processor, data filtering through interaction between the advertising performance chart widgets.

7. The method of claim 6, wherein the performing of the data filtering comprises, in response to a selection on a specific item from one chart widget among the advertising performance chart widgets, filtering data of another chart widget with data corresponding to the specific item.

8. The method of claim 1, further comprising:
providing, by the at least one processor, advertising strategy information based on data being explored through the advertising performance chart widgets.

9. The method of claim 8, wherein the providing of the advertising strategy information comprises recommending the advertising strategy information to optimize at least one of a budget and targeting of an advertising campaign.

10. The method of claim 8, wherein the providing of the advertising strategy information comprises changing settings related to an advertising operation of the advertiser based on the advertising strategy information.

11. A non-transitory computer-readable recording medium storing a computer program that, when executed by a processor, causes the processor to execute the advertising performance report providing method of claim 1 on the computer device.

12. A computer device comprising:
at least one processor configured to execute instructions readable by the computer device,
wherein the at least one processor is configured to perform:
a process of configuring advertising performance data of a unit selected by an advertiser in the form of a visualized chart widget; and
a process of displaying a plurality of advertising performance chart widgets on a data visualization dashboard, and
an interaction functional element is included between the advertising performance chart widgets displayed on the data visualization dashboard.

13. The computer device of claim 12, wherein the at least one processor is configured to, in response to a selection from the advertiser on one of advertising performance indicators or a selection from the advertiser on a single segment that is a unit for grouping advertising-related data and a single advertising performance indicator, configure advertising performance data of a corresponding condition as a chart widget.

14. The computer device of claim 12, wherein the at least one processor configures the advertising performance chart widgets by visualizing the advertising performance data using a chart type selected by the advertiser.

15. The computer device of claim 12, wherein the at least one processor is configured to add or delete the advertising performance chart widgets through the data visualization dashboard.

16. The computer device of claim 12, wherein the at least one processor is configured to display the advertising performance chart widgets using a placement location or order adjusted by the advertiser.

17. The computer device of claim 12, wherein the at least one processor is configured to perform data filtering through interaction between the advertising performance chart widgets.

18. The computer device of claim 17, wherein the at least one processor is configured to, in response to a selection on a specific item from one chart widget among the advertising performance chart widgets, filter data of another chart widget with data corresponding to the specific item.

19. The computer device of claim 12, wherein the at least one processor is configured to provide advertising strategy information based on data being explored through the advertising performance chart widgets.

20. The computer device of claim 19, wherein the at least one processor is configured to change settings related to an advertising operation of the advertiser based on the advertising strategy information.
